(19) United States
(12) Patent Application Publication
(10) Pub. No.: US 2007/0213928 A1
(43) Pub. Date: Sep. 13, 2007

(54) METHOD OF SEARCHING TELEPHONE NUMBER

(75) Inventor: Yu-Jen Chang, Taipei County (TW)

Correspondence Address: J C PATENTS, INC., 4 VENTURE, SUITE 250, IRVINE, CA, 92618, US

(73) Assignee: MITAC INTERNATIONAL CORP., Taoyuan (TW)

(21) Appl. No.: 11/562,252

(22) Filed: Nov. 21, 2006

(30) Foreign Application Priority Data
Mar. 9, 2006 (TW) 95107887

(51) Int. Cl. G01C 21/00

(52) U.S. Cl. 701/208; 701/200

(57) ABSTRACT

A method of searching telephone number suitable for a navigation apparatus is disclosed. First, the navigation apparatus downloads an e-map. The e-map includes a plurality of data points called points of interest (POI). Then, the telephone number of each point of interest in the e-map is collected to produce a telephone number database. When a user's point of interest selection is received, the telephone number corresponding to the point of interest is retrieved from the telephone number database and displayed on the navigation apparatus.

### CROSS-REFERENCE TO RELATED APPLICATION

This application claims the priority benefit of Taiwan application serial no. 95107887, filed Mar. 9, 2006. All disclosure of the Taiwan application is incorporated herein by reference.

### BACKGROUND OF THE INVENTION

1. Field of the Invention

The present invention relates to a method for searching telephone number, and more particularly, to a method of searching telephone number suitable for a navigation apparatus.

2. Description of Related Art

Global position system (GPS) is a guiding system that combines satellite communication and wireless technique to provide the user with accurate position, speed and time information. There are many applications of GPS so that a big market has been created and business opportunities for using GPS technology has also sprung up everywhere. For example, cars or ships can estimate the arrival time and plan a route to a destination through the GPS; an emergency ambulance can accomplish a life-saving mission effectively; and, vehicle driver can find out one's current position and obtain the route to a target destination through an electronic map.

One of the applications of the GPS includes searching the information of a point of interest (POI) on an e-map. First, a user downloads an e-map into a navigation apparatus. Then, through an input device on the navigation apparatus such as a screen keyboard, a desired destination or point of interest is input to the navigation apparatus so that a route to the destination or relevant information about the point of interest is obtained.

However, when the user is guided by the navigation software to a particular point of interest like a shop or a restaurant, it may happen that the shop has not yet opened for business or the restaurant has already been fully booked. Thus, although the navigation apparatus can surely lead a user to the point of interest, the foregoing reasons often prevent the user from actually visiting the shop or enjoying the food inside the restaurant and thus wasting their precious travel time.

Furthermore, when a user uses the foregoing method to search a point of interest, he has to search through layers of input. For example, when the user needs to browse the information regarding a particular restaurant, he must key in “restaurant” first, and then after the navigation apparatus has displayed a list of restaurants, he may find the information about the restaurant from the list. However, if the user only remembers the telephone number of a point of interest without knowing either the name or address of that point of interest, this foregoing method cannot be used to search the point of interest and then navigate a user to the point of interest.

### SUMMARY OF THE INVENTION

Accordingly, at least one objective of the present invention is to provide a method of searching telephone number suitable for a navigation apparatus. By extracting each point of interest data from an e-map to produce a telephone number database, the user can obtain the telephone number of any point of interest.

At least another objective of the present invention is to provide a method of searching telephone number suitable for a navigation apparatus. By extracting each point of interest data from an e-map to produce a telephone number database, the user can find the point of interest information corresponding to the telephone number.

To achieve these and other advantages and in accordance with the purpose of the invention, as embodied and broadly described herein, the invention provides a method of searching telephone number suitable for a navigation apparatus. The method includes the following steps. First, the navigation apparatus downloads an e-map. The e-map includes a plurality of point of interest (POI) data. Then, the telephone number of each point of interest in the e-map is collected to produce a telephone number database. When a user's point of interest selection is received, the telephone number corresponding to the point of interest is retrieved from the telephone number database and displayed on the navigation apparatus.

According to a preferred embodiment of the present invention, the foregoing method of searching telephone number further includes triggering dialing software to dial the telephone number.

According to one preferred embodiment of the present invention, the point of interest data includes name, address, map and description of the point of interest.

According to one preferred embodiment of the present invention, the method of searching the point of interest includes using a stylus or a keyboard.

The present invention also provides an alternative method of searching telephone number suitable for a navigation apparatus. The method includes the following steps. First, the navigation apparatus downloads an e-map. The e-map includes a plurality of point of interest data. Then, the telephone number of each point of interest in the e-map is collected to produce a telephone number database. When a user's input telephone number is received, the point of interest data corresponding to the telephone number is retrieved from the telephone number database and displayed on the navigation apparatus.

According to the preferred embodiment of the present invention, the foregoing method of searching telephone number further includes triggering navigation software and using the point of interest as a target point for planning the navigation.

According to one preferred embodiment of the present invention, the point of interest data includes name, address, map and description of the point of interest.

According to one preferred embodiment of the present invention, the method of inputting the telephone number includes using a stylus or a keyboard.

In the present invention, the telephone data of all the points of interest on an e-map are collected to form a telephone number database. Thus, a user can obtain the telephone number of any point of interest and dial to the location to find out their business status such as business hours and booking conditions before embarking on the journey. Moreover, the telephone number database can link up with the point of interest on the e-map. Therefore, the user can input a telephone number to obtain the corresponding information such as name, address and map of the point of interest.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram showing the steps for searching telephone number information corresponding to a point of interest according to one preferred embodiment of the present invention.

FIG. 2 is a flow diagram showing the steps for searching a point of interest corresponding to a telephone number according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

To provide a better understanding of the nature of the present invention, an embodiment is described in the following to serve as an actual example of the implementation.

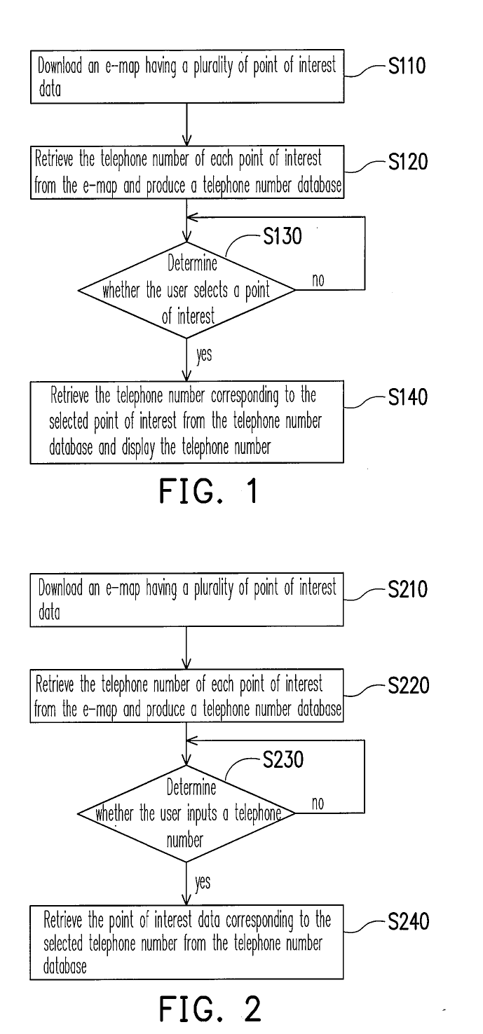

FIG. 1 is a flow diagram showing the steps for searching telephone number information corresponding to a point of interest according to one preferred embodiment of the present invention. As shown in FIG. 1, the method of searching telephone number in the present embodiment is suitable for a navigation apparatus. The method includes the following steps. First, the navigation apparatus downloads an e-map. The e-map includes a plurality of point of interest data, for example, name, address, map and description of the points of interest (in step S110).

Then, the telephone number of each point of interest is retrieved from the e-map and collected to produce a telephone number database (in step S120). After establishing the data in the telephone number database, the navigation apparatus determines whether or not a user has searched a desired point of interest (in step S130). The method of selecting the point of interest includes using a stylus or a keyboard.

When the navigation apparatus receives the user-selected point of interest, the telephone number corresponding to the point of interest is retrieved from the telephone number database and displayed on a screen of the navigation apparatus (in step S140).

It should be noted that, in one embodiment of the present invention, the navigation apparatus further includes a telephone dialing function. After finding the telephone number corresponding to the point of interest, the navigation apparatus can simultaneously trigger the dialing software to dial the telephone number.

FIG. 2 is a flow diagram showing the steps for searching a point of interest corresponding to a telephone number according to another embodiment of the present invention. Referring to FIG. 2, by inputting a telephone number, the navigation apparatus can find the information of a corresponding point of interest. The method includes the following steps. First, the navigation apparatus downloads an e-map. The e-map includes a plurality of point of interest data, for example, name, address, map and description of the point of interest (in step S210).

Then, the telephone number of each point of interest is retrieved from the e-map and collected to produce a telephone number database (in step S220). After establishing the telephone number database, the navigation apparatus determines whether or not a user has input a known telephone number of a point of interest to inquire information corresponding to that point of interest (in step S230). The method of inputting the telephone number includes using a stylus or a keyboard.

Finally, when the navigation apparatus receives the telephone number input by the user, the point of interest information corresponding to the telephone number is retrieved from the telephone number database and displayed on a display screen of the navigation apparatus (in step S240).

In addition, in one embodiment of the present invention, after finding the point of interest corresponding to the telephone number, a navigation software may be triggered and the point of interest may be used as a target point for planning the navigation.

In summary, the method of searching telephone number in the present invention has at least the following advantages:

1. The user can use the point of interest telephone number found in an inquiry to get information regarding the point of interest such as business hours and booking conditions.

2. The entry to obtain point of interest information is not limited to the name or address of the point of interest. If a user knows only the telephone number but not the name of the point of interest, the user can still get the point of interest information through the telephone number alone.

3. The user can find the point of interest by inputting a telephone number. Hence, there is no need to go through layers of input to search the point of interest, thereby shortening the time required for searching the point of interest.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of searching telephone number suitable for a navigation apparatus, comprising:
downloading an e-map having a plurality of point of interest (POI) data;
collecting a telephone number of each point of interest from the e-map to produce a telephone number database;
retrieving the telephone number corresponding to the point of interest from the telephone number database when the navigation apparatus receives a user-selected point of interest; and
displaying the telephone number.

2. The method of claim 1, further comprising:
triggering a dialing software to dial the telephone number.

3. The method of claim 1, wherein the point of interest data comprises name, address, map and description of the point of interest.

4. The method of claim 1, wherein the method of searching the point of interest comprises using a stylus or a keyboard.

5. A method of searching telephone number suitable for a navigation apparatus, comprising:
downloading an e-map having a plurality of point of interest data;
collecting a telephone number of each point of interest on the e-map to produce a telephone number database;
retrieving a point of interest information corresponding to the telephone number from the telephone number database when the navigation apparatus receives a user-input telephone number; and
displaying the point of interest data.

6. The method of claim 5, further comprising:
triggering a navigation software and using the point of interest as a target point in planning a navigation.

7. The method of claim 5, wherein the point of interest data comprises name, address, map and description of the point of interest.

8. The method of claim 5, wherein the method of inputting the telephone number comprises using a stylus or a keyboard.
